(19) United States
(12) Patent Application Publication
(10) Pub. No.: US 2023/0266650 A1
(43) Pub. Date: Aug. 24, 2023

(54) STATIC-PHOSPHOR IMAGE PROJECTOR AND METHOD

(71) Applicant: Optonomous Technologies, Inc., Agoura Hills, CA (US)

(72) Inventor: Kenneth Li, Agoura Hills, CA (US)

(21) Appl. No.: 17/675,594

(22) Filed: Feb. 18, 2022

(51) Int. Cl. G03B 21/20; G02B 26/00; H04N 9/31

(52) U.S. Cl. CPC G03B 21/204; G02B 26/008; G03B 21/2013; G03B 21/2066; G03B 21/208; H04N 9/3161; H04N 9/3164

(57) ABSTRACT

A laser-excited phosphor source of white light modulated and mixed to form homogenized light having a sequence of different colors. Blue excitation laser light is reflected by a wavelength-selective reflector offset from a central optical axis of yellow wavelength-converted light emitted from a phosphor onto which excitation laser light is focused. Having the wavelength-selective reflector offset from the optical axis allows most of the yellow light to bypass the reflector. The yellow light and some of the laser light is collimated and focused through a color wheel into a light tunnel. That light is then focused through a prism pair having an internal interface of a first prism having total-internal-reflection in a first direction towards an imaging device and transmission of light from the imaging device in a second direction. Output light in the second direction is projected as the output beam by projection optics.

### CROSS-REFERENCE TO RELATED APPLICATIONS

This application is related to:
PCT Patent Application No. PCT/US2020/037669, filed Jun. 14, 2020 by Kenneth Li et al., titled “HYBRID LED/LASER LIGHT SOURCE FOR SMART HEADLIGHT APPLICATIONS” (published Dec. 24, 2020 as WO 2020/257091);
U.S. Provisional Pat. Application 62/862,549 titled “ENHANCEMENT OF LED INTENSITY PROFILE USING LASER EXCITATION,” filed Jun. 17, 2019 by Kenneth Li;
U.S. Provisional Pat. Application 62/874,943 titled “ENHANCEMENT OF LED INTENSITY PROFILE USING LASER EXCITATION,” filed Jul. 16, 2019 by Kenneth Li;
U.S. Provisional Pat. Application 62/938,863 titled “DUAL LIGHT SOURCE FOR SMART HEADLIGHT APPLICATIONS,” filed Nov. 21, 2019 by Y.P. Chang et al.;
U.S. Provisional Pat. Application 62/954,337 titled “HYBRID LED/LASER LIGHT SOURCE FOR SMART HEADLIGHT APPLICATIONS,” filed Dec. 27, 2019 by Kenneth Li;
U.S. Provisional Pat. Application No. 62/857,662, filed Jun. 5, 2019 by Chun-Nien Liu et al., titled “Scheme of LIDAR-Embedded Smart Laser Headlight for Autonomous Driving”;
PCT Patent Application PCT/US2019/037231 titled “ILLUMINATION SYSTEM WITH HIGH INTENSITY OUTPUT MECHANISM AND METHOD OF OPERATION THEREOF,” filed Jun. 14, 2019 by Y.P. Chang et al. (published Jan. 16, 2020 as WO 2020/013952);
U.S. Pat. Application 16/509,085 titled “ILLUMINATION SYSTEM WITH CRYSTAL PHOSPHOR MECHANISM AND METHOD OF OPERATION THEREOF,” filed Jul. 11, 2019 by Y.P. Chang et al. (published Jan. 23, 2020 as US 2020/0026169);
U.S. Pat. No. 10,754,236, issued Aug. 25, 2020 to Y.P. Chang et al. and titled “ILLUMINATION SYSTEM WITH HIGH INTENSITY PROJECTION MECHANISM AND METHOD OF OPERATION THEREOF”;
U.S. Provisional Pat. Application 62/837,077 titled “LASER EXCITED CRYSTAL PHOSPHOR SPHERE LIGHT SOURCE,” filed Apr. 22, 2019 by Kenneth Li et al.;
U.S. Provisional Pat. Application 62/853,538 titled “LIDAR INTEGRATED WITH SMART HEADLIGHT USING A SINGLE DMD,” filed May 28, 2019 by Y.P. Chang et al.;
U.S. Provisional Pat. Application 62/871,498 titled “LASER-EXCITED PHOSPHOR LIGHT SOURCE AND METHOD WITH LIGHT RECYCLING,” filed Jul. 8, 2019 by Kenneth Li;
U.S. Provisional Pat. Application 62/857,662 titled “SCHEME OF LIDAR-EMBEDDED SMART LASER HEADLIGHT FOR AUTONOMOUS DRIVING,” filed Jun. 5, 2019 by Chun-Nien Liu et al.;
U.S. Provisional Pat. Application 62/881,927 titled “SYSTEM AND METHOD TO INCREASE BRIGHTNESS OF DIFFUSED LIGHT WITH FOCUSED RECYCLING,” filed Aug. 1, 2019 by Kenneth Li;
U.S. Provisional Pat. Application 62/895,367 titled “INCREASED BRIGHTNESS OF DIFFUSED LIGHT WITH FOCUSED RECYCLING,” filed Sep. 3, 2019 by Kenneth Li; each of which is incorporated herein by reference in its entirety.

### FIELD OF THE INVENTION

This invention relates to the field of image projectors, and more specifically to a method and apparatus to focus blue laser excitation light onto a reflective phosphor substrate mounted on a heatsink, wherein the phosphor substrate emits wavelength-converted yellow light and scatters some of the blue laser light, and the wavelength-converted yellow light and scattered blue laser light are gathered, collimated, and then focused through a rotating color-filter wheel into a light tunnel that mixes the filtered light that is then collimated and propagated through and reflected via a total-internal-reflection (TIR) prism of a two-part prism pair onto a reflective light imager, and the resulting imaged light is transmitted back through the two-part prism pair, without TIR, and through a projection lens assembly to be projected output light of the system.

### BACKGROUND OF THE INVENTION

U.S. Pat. Application Publication 2021/0195151 by Takahashi published on Jun. 24, 2021 with the title “Phosphor Member, Light Source Device, Projector and Chromaticity Adjustment Method” and is incorporated herein by reference. Publication 2021/0195151 describes a phosphor member that includes: a phosphor plate that converts a part of excitation light into fluorescent light and emits mixed color light including the fluorescent light and the remaining part of the excitation light; and a reflective layer that is provided on the phosphor plate and that transmits a part of the mixed color light and reflects the remaining part.

What is needed is an improved system and method for generating white light for filtering through a rotating color-filter wheel to form a color-filtered beam that includes a repeating sequence of red, green, and blue (RGB) wavelengths or a repeating sequence of red, green, blue and white (RGBW) wavelengths, and then modulating the filtered colored light with an imager and projecting the resulting images wherein the system is smaller, simpler and more efficient than conventional image-projection systems.

### SUMMARY OF THE INVENTION

Laser-excited phosphor produces white light with higher brightness than LEDs, and is a preferred light source for projectors with high output and long life. In addition, reflective phosphor allows better heat sinking compared to transmissive phosphor, as the reflective phosphor plate can be mounted on heatsinks for efficient cooling, in contrast to a transmissive phosphor plate that is suspended in air without any mechanical contact (for removing heat) to the emission region. Further, in conventional systems, both the laser-excitation-light optical path and the output optical path overlap, making it difficult to design the optics and maintain light efficiency. The present invention includes an optical configuration where the excitation and output optics are placed to minimize inference and losses.

In some embodiments, the present invention includes a laser-excited phosphor source of white light that is modulated by a rotating color wheel having a plurality of different color wavelength-selective filters, and mixed using a light tunnel to form homogenized light having a sequence of different colors. Blue excitation laser light is reflected toward a phosphor plate by a wavelength-selective reflector that is offset from a central optical axis (typically a normal vector from the surface of the phosphor plate, which is also typically a central optical axis of the collimating and focusing lenses 131 and 132) of yellow wavelength-converted light emitted in a Lambertian distribution from the phosphor plate onto which excitation laser light is focused. One important aspect of the invention is having the wavelength-selective reflector offset from the central optical axis, which allows most of the scattered blue light to bypass the reflector. The yellow light and some of the laser light that has not been converted is collimated and focused through a color wheel into a light tunnel, which spatially homogenizes the sequence of different colors. That light is then focused through a prism pair having an internal interface having total-internal-reflection in a first direction, towards an imaging device, and transmission of light from the imaging device is in a second direction. Output light in the second direction is projected as the output beam by projection optics.

In some embodiments, the present invention provides a projector system that includes: a light-source module and a projection module. The light-source module includes:
a laser array that outputs laser light having at least one excitation wavelength, wherein the laser array is mounted on a first heatsink,
a phosphor plate mounted on a reflective second heatsink, wherein the phosphor plate, when illuminated by the laser light, emits wavelength-converted light that includes a range of wavelengths longer than the laser light in approximately Lambertian spatial distribution, and wherein the phosphor plate scatters at least some of the laser light from the laser array;
a first lens that receives light from the phosphor plate and collimates that light into a collimated beam having an optical axis,
a second lens that receives light of the collimated beam, wherein the second lens focuses that light,
a wavelength-selective reflector positioned between the first lens and the second lens and oriented at an acute angle relative to the optical axis but positioned to a side of the optical axis, wherein the wavelength-selective reflector is configured to reflect wavelengths of the laser light from the laser array toward the first lens, wherein the first lens focuses the reflected light onto the phosphor plate, and wherein the wavelength-selective reflector is configured to transmit the range of wavelengths of the wavelength-converted light from the phosphor plate toward the second lens,
a light tunnel configured to spatially mix light entering through a first end of the light tunnel and to pass the mixed light out a second end of the light tunnel, and
a color wheel configured to rotate around a rotational axis, wherein the color wheel includes a plurality of wavelength-selective-filter areas each of which passes a different sub-range of visible-light colors, wherein the color wheel is positioned between the second lens and the light tunnel, and wherein light focused by the second lens is filtered by the rotating color-filter wheel and then enters the first end of the light tunnel as a repeating sequence of different colors, and the light tunnel spatially homogenizes the repeating sequence of different colors to form an intermediate output beam of the light source module.
The projection module includes:
a prism pair that includes a first prism and a second prism, wherein the first prism is configured to reflect, by total internal reflection (TIR) at a TIR face of the first prism, light received into a first face of the first prism to exit a second face of the first prism, wherein the first prism is configured to transmit light received into the second face through the TIR face, and wherein the second prism is configured to pass light that was received through the TIR face of the first prism out through an output face of the second prism,
an imager,
collimating optics configured to receive light from the light-source module and to focus that light through the prism pair onto the imager, and
projection optics configured receive light from the output face of the second prism and to project that light as an output beam of the projector.

In some embodiments, the present invention provides a laser-excited-phosphor light source that includes: a laser array that outputs laser light having at least one excitation wavelength, wherein the laser array is mounted on a first heatsink; a phosphor plate mounted on a reflective second heatsink, wherein the phosphor plate, when illuminated by the laser light, absorbs some of the laser light and emits wavelength-converted light that includes a range of wavelengths longer than the laser light in Lambertian spatial distribution, and wherein the phosphor plate scatters, rather than absorbs, at least some of the laser light from the laser array; a first lens that receives light from the phosphor plate and collimates that light into a collimated beam having an optical axis; a second lens that receives light of the collimated beam, wherein the second lens focuses that light; a wavelength-selective reflector positioned between the first lens and the second lens and oriented at an acute angle relative to the optical axis but positioned offset to a side of the optical axis, wherein the wavelength-selective reflector is configured to reflect wavelengths of the laser light from the laser array toward the first lens, wherein the first lens focuses the reflected light onto the phosphor plate, and wherein the wavelength-selective reflector is configured to transmit the range of wavelengths of the wavelength-converted light from the phosphor plate toward the second lens; a light tunnel configured to spatially mix light entering through a first end of the light tunnel and to pass the mixed light out a second end of the light tunnel; and a color-filter wheel operatively coupled to a rotation motor and configured to rotate around a rotational axis, wherein the color-filter wheel is positioned between the second lens and the light tunnel, and wherein light focused by the second lens is filtered by the rotating color-filter wheel and then enters the first end of the light tunnel as a repeating sequence of different colors, and the light tunnel spatially homogenizes the repeating sequence of different colors to form an output beam of the light source.

In some embodiments, the present invention provides a method that includes: providing a color wheel that includes a plurality of wavelength-selective-filter areas each of which passes a different sub-range of visible-light colors; rotating the color wheel around a rotational axis; generating laser light having at least one excitation wavelength; providing a phosphor plate mounted on a reflective second heatsink, wherein the phosphor plate, when illuminated by laser light, absorbs some of the laser light and emits wavelength-converted light that includes a range of wavelengths longer than the laser light, wherein the emitted wavelength-converted light has a Lambertian spatial distribution, and wherein the phosphor plate scatters, rather than absorbs, at least some of the laser light; collimating light from the phosphor plate into a collimated beam having an optical axis; reflecting the laser light using a wavelength-selective reflector oriented at an acute angle relative to the optical axis but positioned offset to a side of the optical axis, wherein the wavelength-selective reflector is configured to reflect wavelengths of the laser light toward the phosphor plate as reflected laser light; focusing the reflected laser light onto the phosphor plate, wherein the wavelength-selective reflector is configured to transmit the range of wavelengths of the wavelength-converted light from the phosphor plate that are in a portion of the collimated beam that impinges on the wavelength-selective reflector; focusing the collimated beam through the rotating color wheel and filtering the focused collimated beam through successive ones of the plurality of wavelength-selective-filter areas to form a beam having a repeating sequence of different colors; and homogenizing the beam having the repeating sequence of different colors to form a homogenized beam having the repeating sequence of different colors.

### BRIEF DESCRIPTION OF THE DRAWINGS

FIG. 1A is a side-view cross-sectional block diagram of a light-source module 101 that has an input blue laser light 112 having parallel beams from a laser array 110 and an output beam 169 that includes mixed colored light of three (e.g., RGB) or four (e.g., RGBW) different colors outputted in a repeating temporal sequence, according to some embodiments of the present invention.

FIG. 1B is a side-view cross-sectional block diagram of a light-source module 102 that has a plurality of inputs of blue laser light 112A - 112B, each having parallel beams from a plurality of laser arrays 110A-110B and an output beam 169 that includes mixed colored light of three (e.g., RGB) or four (e.g., RGBW) different colors outputted in a repeating temporal sequence, according to some embodiments of the present invention.

FIG. 2A is a front-view diagram of a flat transparent glass plate 120A having a wavelength-selective reflector portion 122 that reflects blue light of at least the wavelengths of laser array 110 and that passes other visible wavelengths of light, according to some embodiments of the present invention.

FIG. 2B is a front-view diagram of a flat transparent glass plate 120B having a plurality of wavelength-selective reflector portions 122A-122F that each reflects blue light of at least the wavelengths of laser arrays 110A-110B and that passes other visible wavelengths of light, according to some embodiments of the present invention.

FIG. 3 is a side-view cross-sectional block diagram of a projector system 301 that includes light-source module 101 and projector module 310, according to some embodiments of the present invention.

FIG. 4 is a front view diagram of a color wheel 401 that includes three colored transmissive segments, each of which substantially transmits one range of wavelengths of a selected color (e.g., in some embodiments, red, green or blue) and substantially blocks wavelengths of other colors, according to some embodiments of the present invention.

FIG. 5 is a front view diagram of a color wheel 501 that includes three colored transmissive segments and one clear segment, wherein each of the three colored segments substantially transmits one range of wavelengths of a selected color (e.g., in some embodiments, red, green or blue) and substantially blocks wavelengths of other colors, and wherein the clear segment passes substantially all visible wavelengths of light, according to some embodiments of the present invention.

### DESCRIPTION OF PREFERRED EMBODIMENTS OF PART A OF THE INVENTION

Although the following detailed description contains many specifics for the purpose of illustration, a person of ordinary skill in the art will appreciate that many variations and alterations to the following details are within the scope of the invention. Specific examples are used to illustrate particular embodiments; however, the invention described in the claims is not intended to be limited to only these examples, but rather includes the full scope of the attached claims. Accordingly, the following preferred embodiments of the invention are set forth without any loss of generality to, and without imposing limitations upon the claimed invention. Further, in the following detailed description of the preferred embodiments, reference is made to the accompanying drawings that form a part hereof, and in which are shown by way of illustration specific embodiments in which the invention may be practiced. It is understood that other embodiments may be utilized and structural changes may be made without departing from the scope of the present invention. The embodiments shown in the Figures and described here may include features that are not included in all specific embodiments. A particular embodiment may include only a subset of all of the features described, or a particular embodiment may include all of the features described.

The leading digit(s) of reference numbers appearing in the Figures generally corresponds to the Figure number in which that component is first introduced, such that the same reference number is used throughout to refer to an identical component which appears in multiple Figures. Signals and connections may be referred to by the same reference number or label, and the actual meaning will be clear from its use in the context of the description.

Certain marks referenced herein may be common-law or registered trademarks of third parties affiliated or unaffiliated with the applicant or the assignee. Use of these marks is for providing an enabling disclosure by way of example and shall not be construed to limit the scope of the claimed subject matter to material associated with such marks.

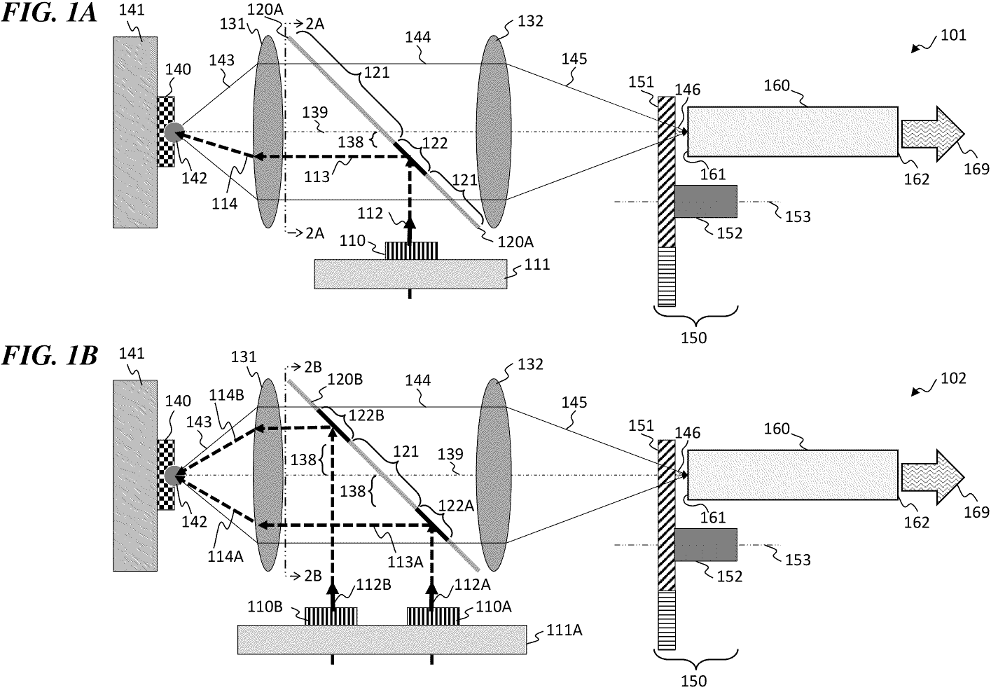

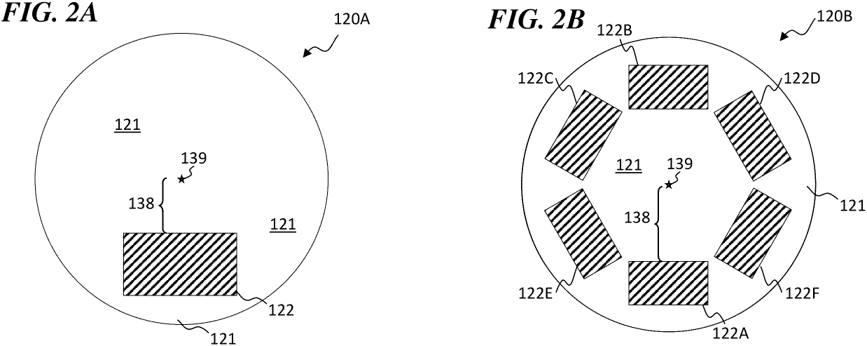

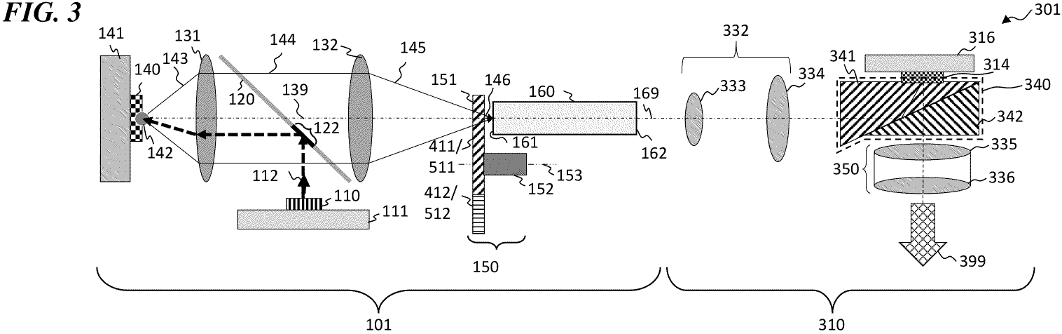

FIG. 1A is a side-view cross-sectional block diagram of a light-source module 101 that has an input blue laser light 112 having parallel beams from a laser array 110 and an output beam 169 that includes mixed colored light of three (e.g., RGB) or four (e.g., RGBW) different colors outputted in a repeating temporal sequence, according to some embodiments of the present invention. In some embodiments, light-source module 101 includes a laser array 110 mounted on a heatsink 111, a wavelength-selective reflector 122 that reflects blue laser light 112 to form reflected laser light 113, a first lens 131 that focuses reflected laser light 113 to form focused laser light 114 that is focused to an area 142 on yellow-phosphor plate 140, which is mounted to heatsink 141. The shape of the reflector 122 is preferably designed to match the shape of the blue laser beam, e.g. rectangular, circular, etc. In some embodiments, yellow-phosphor plate 140 is excited by the focused laser light 114 that came from laser array 110, which includes a plurality laser diodes that each emits one of a plurality of respective collimated laser beams (each of which includes one or more wavelengths that are blue in color - e.g., in some embodiments, wavelengths between 400 nm and 500 nm) that form laser light 112. The laser light 112 output from laser array 110 is directed towards wavelength-selective reflector 122 (a partial reflector that reflects substantially all of the one or more blue wavelengths of laser light 112, such that the blue laser light is reflected toward the lens 131, which is the focusing lens for the reflected laser beams 113, and which also collimates the light 143 from phosphor plate 140 to form collimated beam 144. The focused blue laser light 114 (which is focused across an area 142 on phosphor plate 140) is wavelength converted to yellow light and emitted at the phosphor plate 140 surface with a Lambertian angular distribution centered (or at least approximately centered) on optical axis 139 of lenses 131 and 132. The heat generated by absorption of the laser beams 114 on and in the phosphor plate 140, and by the wavelength-conversion process, is conducted away through heatsink 141 and eventually dissipated (e.g., by passive air convection, by forced fan air, by liquid cooling or other means well known in the art). The output yellow emission, together with the left-over, scattered and/or reflected blue light, produces white light output 143, and is collimated by lens 131 to form collimated beam 144, such that the majority of the white light bypasses wavelength-selective reflector 122, and the yellow wavelengths of collimated beam 144 that impinge on wavelength-selective reflector 122 are transmitted through wavelength-selective reflector 122. In some embodiments, a clear transparent plate 120A (which, in some embodiments, is made of glass, and has a front view shown in FIG. 2A as seen from cut line 2A) is used onto which a small area 122, offset (e.g., by distance 138) to a side of optical axis 139, is used for wavelength-selective reflector 122 to reflect the blue laser light 112 while transmitting yellow light, and the remaining area 121 is clear and thus transmits all wavelengths. In some other embodiments, the transparent plate is omitted and one or more wavelength-selective reflectors 122 are mounted using a smaller piece of transparent substrate (such as glass) or other support that minimizes blockage of the white light of collimated beam 144. In some embodiments, area 121 has an antireflection coating to improve its transmission properties. The details of one embodiment of a glass plate 120A (which includes an area having partial reflector 122, wherein partial reflector 122 is offset from where optical axis 139 intersects transparent plate 120A (in some embodiments, optical axis 139 goes through a center of the transparent plate) by distance 138) are shown in FIG. 2A. The transmitted white light of collimated beam 144 is then focused by lens 132 to form converging beam 145 that is wavelength-filtered through rotating color wheel 151 that is rotated by motor 152 (which together form color-wheel assembly 150) around axis 153, such that beam 146 with sequential colors, e.g., red, green and blue (RGB) or red, green, blue and white (RGBW), is produced, and beam 146 is homogenized by light tunnel 160 to form intermediate beam 169 having the homogenized repeating sequence of different colors. In some embodiments, intermediate beam 169 of light source module 101 is used for driving a sequential color projection engine not shown in FIG. 1A, but one example of which is shown in FIG. 3. In some embodiments, light tunnel 160 has straight parallel sides (either circular, oval or polygonal in cross section) or in other embodiments, light tunnel 160 is tapered, with different input and output surface areas. In some embodiments, light tunnel 160 is square or rectangular in cross section. In some embodiments, light tunnel 160 is a solid transparent rod with total internal reflection surfaces. In some embodiments, for very high power operations, phosphor plate 140 is a rotating reflective phosphor plate mounted to a heatsink 141 that is rotating.

FIG. 1B is a side-view cross-sectional block diagram of a light-source module 102 that has a plurality of inputs of blue laser light 112A - 112B, each having parallel beams from a plurality of laser arrays 110A-110B and an output beam 169 that includes mixed colored light of three (e.g., RGB) or four (e.g., RGBW) different colors outputted in a repeating temporal sequence, according to some embodiments of the present invention. In some embodiments, clear transparent plate 120B (which, in some embodiments, is made of glass and has a front view shown in FIG. 2B as seen from cut line 2B) includes a plurality of wavelength-selective blue-reflecting yellow-transmitting partial reflectors 122A and 122B and optionally more of such partial reflectors arranged around the glass plate near its circumference, each reflector 122A-122F being offset (e.g., by a radial distance 138) to a side of where optical axis 139 intersects plate 120B. Wavelength-selective reflectors 122A-122F are used to reflect the blue laser light 112A and 112B while transmitting yellow light, and the remaining area 121 is clear and thus transmits all wavelengths. In some embodiments, laser arrays 110A-110B are all mounted in a single plane as shown here, while in other embodiments, laser arrays 110A-110B are mounted in different planes, with suitable angled wavelength-selective reflectors.

FIG. 2A is a front-view diagram of a flat transparent plate 120A, as used in some embodiments. Transparent plate 120A (which is shown here as a front view, as viewed from cut line 2A of FIG. 1A) includes a wavelength-selective reflector portion 122 (e.g., in some embodiments, an area that is offset (e.g., by a radial distance 138 to a side of where optical axis 139 intersects transparent plate 120A), wherein the area is coated by a plurality of dielectric layers of different refractive indices) that reflects blue light of at least the wavelengths of laser array 110 and a clear portion 121 that passes both blue light of the wavelengths of laser array 110 as well as other visible wavelengths of light, according to some embodiments of the present invention. In some embodiments, reflector 122 on transparent plate 120A is coated with a blue-reflective/yellow-transmissive coating, while the remaining area 121 is highly transmissive to all visible wavelengths of light. In some embodiments, the wavelength-selective reflector 122 includes a multi-layer dielectric film, which reflects only the narrow linewidth wavelength(s) of laser diode array 110. As a result, wavelength-selective reflector 122 does not block the yellow emission from the phosphor. On the other hand, wavelength-selective reflector 122 blocks the scattered blue light from the phosphor surface, this reducing the efficiency. In some embodiments, it is important to minimize the area of blockage and it is preferred that the blue reflector 122 is near the edge of transparent plate 120A, where the intensity of the Lambertian distribution is lower, and it is not be advisable to have this reflective area 122 near the center where the loss of blue light is at the maximum. The location of the blue reflective area 122 can also be chosen to adjust the blue-light-to-yellow-light ratio, in order to achieve the required or desired color temperature of a particular application. In other embodiments, (shown in FIG. 1B), the laser light source includes a plurality of separated laser-light sources, with a corresponding number of separated areas (e.g., in some such embodiments, one circular area or, as shown in FIG. 2B, two or more areas near and spaced around the circumference of glass plate 120B), each area having a wavelength-selective blue reflector directing the laser light from a corresponding one of the plurality of laser-light sources towards the phosphor plate.

FIG. 2B is a front-view diagram of a flat transparent plate 120B having a plurality of wavelength-selective reflector portions 122A and 122B and optionally also wavelength-selective reflector portions 122C, 122D, 122E and 122F that each reflects blue light of at least the wavelengths of laser arrays 110A-110B and that passes other visible wavelengths of light, according to some embodiments of the present invention. In some embodiments, transparent plate 120B (which, in some embodiments, is made of glass and has a front view, as viewed from cut line 2B of FIG. 1B) includes a plurality of small wavelength-selective reflectors 122A-122F (see FIG. 2B), each offset (e.g., by a radial distance 138) to a side of where optical axis 139 intersects transparent plate 120B.

FIG. 3 is a side-view cross-sectional block diagram of a projector system 301 that includes light-source module 101 and projector module 310, according to some embodiments of the present invention. FIG. 3 shows an example of a projector system 301 that uses the invention shown in FIG. 1 as light source module 101. The output 169 from light tunnel 160 is coupled to the projection module as shown. In some embodiments, output 169 from light tunnel 160 is imaged onto the imager 314 (mounted on heatsink 316) with the designed magnification with the lens system 332 that includes coupling lenses 333 and 334, and reflected by TIR of TIR prism 341 of TIR prism pair 340, wherein TIR prism pair 340 also include prism 342to imager 314 mounted on heat sink 316. In some embodiments, imager 314 includes, e.g., a multiple-mirror DMD (digital micromirror device), which, in some embodiments, is configured in a Digital Light Processing (DLP) projector. The reflected output from imager 350 passes through the combined TIR prism pair 340 (including TIR prism 341 and prism 342, with prism 342 providing an angularly corrected output beam in the desired output direction) without TIR at the interface between prism 341 and prism 342, and out through projection lens system 330, which includes lenses 335 and 336, exiting as output light 399. In some embodiments, output 399 is then projected onto a screen (not shown). In some embodiments (not shown), a projection system substantially similar to those shown and described in P.C.T. Patent Application Publication WO 2020/257091 by Kenneth Li et al., titled “HYBRID LED/LASER LIGHT SOURCE FOR SMART HEADLIGHT APPLICATIONS” is used, including the TIR prism pair and imager, but in contrast to the embodiments of Publication WO 2020/257091, one or more blue-reflecting yellow-transmitting wavelength-selective reflector(s) are located offset to the side(s) of the central optical axis, in order to reduce blockage of the blue-wavelength portions of the output beam, and a rotating-color-wheel assembly 150 and light tunnel 160 are added in the optical path between the laser-excited phosphor assembly and the TIR-prism pair 340 and imager to provide homogenized light have a repeating sequence of different colors.

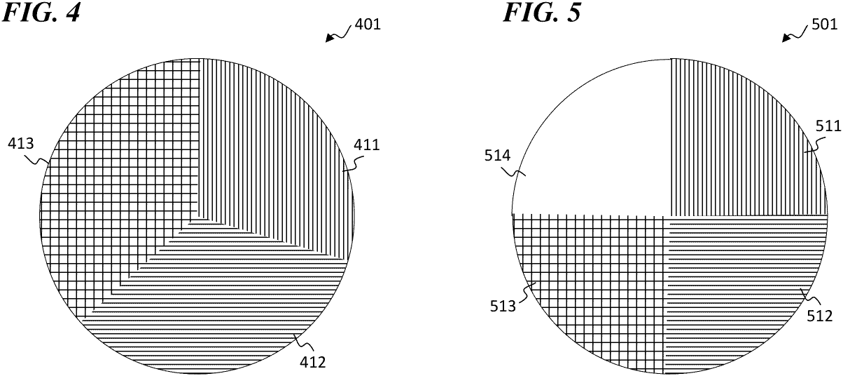

FIG. 4 is a front view diagram of a color wheel 401 that includes three transmissive color-filter segments 411, 412, and 413, each of which substantially transmits one range of wavelengths of a selected color (e.g., in some embodiments, red, green or blue, respectively) and substantially blocks wavelengths of other colors, according to some embodiments of the present invention. In some embodiments, white light from the light source (e.g., light 145 of FIG. 1A) passes through the color wheel, which, as it rotates, successively outputs red through the red filter, output green through the green filter and output blue through the blue filter. Optionally, a diffusive filter, diffusive internal structure, or diffusive surface layer is added to one or more of the color-filter segments 411, 412, and 413 to minimize the speckle from the blue laser light, as needed.

FIG. 5 is a front view diagram of a color wheel 501 that includes three transmissive color-filter segments 511, 512, and 513 and one clear segment 514, wherein each of the three color-filter segments 511, 512, and 513 substantially transmits one range of wavelengths of a selected color (e.g., in some embodiments, red, green or blue) and substantially blocks wavelengths of other colors, and wherein the clear segment 514 passes substantially all visible wavelengths of light, according to some embodiments of the present invention. Similar to the RGB color wheel 401 shown in FIG. 4, FIG. 5 shows a diagram of a RGBW color wheel 501 with the operation of RGB similar to that of FIG. 4. For the white-light-transmitting clear segment 514, in some embodiments, simply a glass plate without any wavelength-selective coating is used. Optionally, in some embodiments a diffusive filter is added to one or more of filter segments 511, 512, 513 and/or un-coated white segment 514 to minimize speckles (speckle from the blue laser light), as needed. In some embodiments, coatings with anti-reflection properties are added to color-filter segments 511, 512, 513, and/or clear segment 514 to increase efficiency. In addition, in some embodiments, optional diffusers are added for increased uniformity of the projected screen intensities.

In some embodiments, the present invention provides a projector system 301 that includes: a light-source module 101 and a projection module 310. The light-source module 101 includes:
a laser array 110 that outputs laser light 112 having at least one excitation wavelength, wherein the laser array 110 is mounted on a first heatsink 111,
a phosphor plate 140 mounted on a reflective second heatsink 141, wherein the phosphor plate 140, when illuminated by the laser light 112, absorbs some of the laser light and emits wavelength-converted light 143 that includes a range of wavelengths longer than the at least one excitation wavelength of the laser light in Lambertian spatial distribution, and wherein the phosphor plate 140 scatters and/or reflects, rather than absorbs, at least some of the laser light 112 from the laser array 110;
a first lens 131 that receives light from the phosphor plate and collimates that light into a collimated beam 144 having an optical axis 139,
a second lens 132 that receives light of the collimated beam 144, wherein the second lens 132 focuses that light it a converging beam 145,
a wavelength-selective reflector 122 positioned between the first lens 131 and the second lens 132 and oriented at an acute angle relative to the optical axis 139 but positioned to a side of (offset by a distance 138) the optical axis 139, wherein the wavelength-selective reflector 122 is configured to reflect wavelengths of the laser light 112 from the laser array 110 toward the first lens 131, wherein the first lens 131 focuses the reflected light 113 onto the phosphor plate 140, and wherein the wavelength-selective reflector 122 is configured to transmit the range of wavelengths of the wavelength-converted light 143 from the phosphor plate 140 toward the second lens 132,
a light tunnel 160 configured to spatially mix light 146 entering through a first end 161 of the light tunnel and to pass the mixed light out a second end 162 of the light tunnel 160, and
a color wheel 151 configured to rotate around a rotational axis 153, wherein the color wheel 151 includes a plurality of wavelength-selective-filter areas (e.g., 411, 412, and 413 of FIG. 4, or 511, 512, and 513 of FIG. 5), each of which passes a different sub-range of visible-light colors, wherein the color wheel 151 is positioned between the second lens 132 and the light tunnel 160, and wherein light 145 focused by the second lens 132 is filtered by the rotating color-filter wheel 151 to form a sequence of different colors of light 146, and then enters the first end 161 of the light tunnel 160 as the repeating sequence of different colors, and the light tunnel 160 spatially homogenizes the repeating sequence of different colors to form an intermediate output beam 169 of the light source module 101.
The projection module 310 includes:
a prism pair 340 that includes a first prism 341 and a second prism 342, wherein the first prism 341 is configured to reflect, by total internal reflection (TIR) at a TIR face of the first prism, light received into a first face of the first prism 341 to exit a second face of the first prism 341, wherein the first prism 341 is configured to transmit light received into the second face through the TIR face, and wherein the second prism 342 is configured to pass light that was received through the TIR face of the first prism 341 out through an output face of the second prism 342,
an imager 314,
collimating optics 332 configured to receive light from the light-source module and to focus that light through the prism pair 340 onto the imager 314, and
projection optics 350 configured receive light from the output face of the second prism and to project that light as an output beam 399 of the projector 301.

In some embodiments of the projector module 310, the imager 314 includes a digital micromirror-array device (DMD) having a two-dimensional (2D) array of micromirrors configured to spatially modulate each one of the repeating sequence of different colors to form a spatially modulated beam having a 2D array of pixels in the projected colored moving-image output beam.

In some embodiments of the light-source module 101, the wavelength-selective reflector(s) 122, 122A, 122B, 122C, 122D, 122E and/or 122F is/are deposited only onto one or more selected areas on a transparent plate 120A or 120B, and the one or more selected areas are offset from where the optical axis 139 intersects the transparent plate 120A or 120B.

In some embodiments of the light-source module 101, the wavelength-selective reflector(s) 122, 122A, 122B, 122C, 122D, 122E and/or 122F is/are deposited only onto one or more selected areas on a glass plate 120A or 120B, the one or more selected areas is/are offset from where the optical axis 139 intersects the glass plate, and the glass plate is oriented at a 45-degree angle to the optical axis 139.

In some embodiments of the light-source module 101, the laser light reflected from the one or more wavelength-selective reflector(s) 122, 122A, 122B, 122C, 122D, 122E and/or 122F passes through a first area of the first lens 131 that is offset to a first side of the optical axis 139, wherein the phosphor plate 140 also reflects at least some of the laser light from the laser array 110 toward a second area of the first lens offset to an opposite side of the optical axis 139 relative to the first area such that the collimated beam 144 includes the reflected light in a portion of the collimated beam 144 offset on an opposite side of the optical axis 139 relative to the wavelength-selective reflector 122, and wherein a majority of the wavelength-converted light is in portions of the collimated beam 144 that bypass the wavelength-selective reflector 122.

In some embodiments of the light-source module 101, the laser array 110 includes a plurality of respective lasers that each emit laser light, wherein the laser light is formed into a plurality of respective parallel collimated laser beams, wherein each laser beam includes at least one excitation wavelength that is blue in color, and wherein the wavelength-converted light.

In some embodiments of the light-source module 101, a majority of the wavelength-converted light is in portions of the collimated beam 144 that bypass the wavelength-selective reflector.

It is to be understood that the above description is intended to be illustrative, and not restrictive. Although numerous characteristics and advantages of various embodiments as described herein have been set forth in the foregoing description, together with details of the structure and function of various embodiments, many other embodiments and changes to details will be apparent to those of skill in the art upon reviewing the above description. The scope of the invention should be, therefore, determined with reference to the appended claims, along with the full scope of equivalents to which such claims are entitled. In the appended claims, the terms “including” and “in which” are used as the plain-English equivalents of the respective terms “comprising” and “wherein,” respectively. Moreover, the terms “first,” “second,” and “third,” etc., are used merely as labels, and are not intended to impose numerical requirements on their objects.

What is claimed is:

1. A projector for projecting a moving image, the projector comprising:
a light-source module; and
a projection module,
wherein the light-source module includes:
a laser array that outputs laser light having at least one excitation wavelength, wherein the laser array is mounted on a first heatsink,
a phosphor plate mounted on a reflective second heatsink, wherein the phosphor plate, when illuminated by the laser light, emits wavelength-converted light that includes a range of wavelengths longer than the laser light in approximate Lambertian spatial distribution, and wherein the phosphor plate scatters at least some of the laser light from the laser array,
a first lens that receives light from the phosphor plate and collimates that light into a collimated beam having an optical axis,
a second lens that receives light of the collimated beam, wherein the second lens focuses that light,
a wavelength-selective reflector positioned between the first lens and the second lens and oriented at an acute angle relative to the optical axis but positioned to a side of the optical axis, wherein the wavelength-selective reflector is configured to reflect wavelengths of the laser light from the laser array toward the first lens, wherein the first lens focuses the reflected light onto the phosphor plate, and wherein the wavelength-selective reflector is configured to transmit the range of wavelengths of the wavelength-converted light from the phosphor plate toward the second lens,
a light tunnel configured to spatially mix light entering through a first end of the light tunnel and to pass the mixed light out a second end of the light tunnel, and
a color wheel configured to rotate around a rotational axis, wherein the color wheel includes a plurality of wavelength-selective-filter areas each of which passes a different sub-range of visible-light colors, wherein the color wheel is positioned between the second lens and the light tunnel, and wherein light focused by the second lens is filtered by the rotating color-filter wheel and then enters the first end of the light tunnel as a repeating sequence of different colors, and the light tunnel spatially homogenizes the repeating sequence of different colors to form an intermediate output beam of the light source module; and
wherein the projection module includes:
a prism pair that includes a first prism and a second prism, wherein the first prism is configured to reflect, by total internal reflection (TIR) at a TIR face of the first prism, light received into a first face of the first prism to exit a second face of the first prism, wherein the first prism is configured to transmit light received into the second face through the TIR face, and wherein the second prism is configured to pass light that was received through the TIR face of the first prism out through an output face of the second prism,
an imager,
collimating optics configured to receive light from the light-source module and to focus that light through the prism pair onto the imager, and
projection optics configured receive light from the imager through the output face of the second prism and to project that light as a colored moving-image output beam of the projector.

2. The projector of claim 1,
wherein the wavelength-selective reflector is deposited only onto a selected area on a transparent plate, and
wherein the selected area is offset from where the optical axis intersects the transparent plate.

3. The projector of claim 1,
wherein the wavelength-selective reflector is deposited only onto a selected area on a glass plate,
wherein the selected area is offset from where the optical axis intersects the glass plate, and
wherein the glass plate is oriented at a 45-degree angle to the optical axis.

4. The projector of claim 1,
wherein the laser light reflected from the wavelength-selective reflector passes through a first area of the first lens that is offset to a first side of the optical axis,
wherein the phosphor plate also reflects at least some of the laser light from the laser array toward a second area of the first lens offset to an opposite side of the optical axis relative to the first area such that the collimated beam includes the reflected light in a portion of the collimated beam offset on an opposite side of the optical axis relative to the wavelength-selective reflector, and
wherein a majority of the wavelength-converted light is in portions of the collimated beam that bypass the wavelength-selective reflector.

5. The projector of claim 1,
wherein the laser array includes a plurality of respective lasers that each emit laser light,
wherein the laser light is formed into a plurality of respective parallel collimated laser beams,
wherein each laser beam includes at least one excitation wavelength that is blue in color, and
wherein the wavelength-converted light.

6. The projector of claim 1, wherein a majority of the wavelength-converted light is in portions of the collimated beam that bypass the wavelength-selective reflector.

7. The projector of claim 1, wherein the imager includes a digital micromirror-array device (DMD) having a two-dimensional (2D) array of micromirrors configured to spatially modulate each one of the repeating sequence of different colors to form a spatially modulated beam having a 2D array of pixels in the projected colored moving-image output beam.

8. A laser-excited-phosphor light source comprising:
a laser array that outputs laser light having at least one excitation wavelength, wherein the laser array is mounted on a first heatsink;
a phosphor plate mounted on a reflective second heatsink, wherein the phosphor plate, when illuminated by the laser light, emits wavelength-converted light that includes a range of wavelengths longer than the laser light in Lambertian spatial distribution, and wherein the phosphor plate scatters at least some of the laser light from the laser array;
a first lens that receives light from the phosphor plate and collimates that light into a collimated beam having an optical axis;
a second lens that receives light of the collimated beam, wherein the second lens focuses that light;
a wavelength-selective reflector positioned between the first lens and the second lens and oriented at an acute angle relative to the optical axis but positioned offset to a side of the optical axis, wherein the wavelength-selective reflector is configured to reflect wavelengths of the laser light from the laser array toward the first lens, wherein the first lens focuses the reflected light onto the phosphor plate, and wherein the wavelength-selective reflector is configured to transmit the range of wavelengths of the wavelength-converted light from the phosphor plate toward the second lens;
a light tunnel configured to spatially mix light entering through a first end of the light tunnel and to pass the mixed light out a second end of the light tunnel; and
a color-filter wheel operatively coupled to a rotation motor and configured to rotate around a rotational axis, wherein the color-filter wheel is positioned between the second lens and the light tunnel, and wherein light focused by the second lens is filtered by the rotating color-filter wheel and then enters the first end of the light tunnel as a repeating sequence of different colors, and the light tunnel spatially homogenizes the repeating sequence of different colors to form an output beam of the light source.

9. The laser-excited-phosphor light source of claim 8, wherein the wavelength-selective reflector is deposited only onto one or more selected areas on a transparent plate, and wherein the one or more selected areas are each offset from where the optical axis intersects the transparent plate.

10. The laser-excited-phosphor light source of claim 8, wherein the wavelength-selective reflector is deposited only onto a selected area on a glass plate, wherein the selected area is offset from where the optical axis intersects the glass plate, and wherein the glass plate is oriented at a 45-degree angle to the optical axis.

11. The laser-excited-phosphor light source of claim 8, wherein the laser light reflected from the wavelength-selective reflector passes through a first area of the first lens that is offset to a first side of the optical axis, and wherein the phosphor plate also reflects at least some of the laser light from the laser array toward a second area of the first lens offset to an opposite side of the optical axis relative to the first area such that the collimated beam includes the reflected light in a portion of collimated beam offset on an opposite side of the optical axis relative to the wavelength-selective reflector, and wherein a majority of the wavelength-converted light is in portions of the collimated beam that bypass the wavelength-selective reflector.

12. The laser-excited-phosphor light source of claim 8, wherein the laser array includes a plurality of respective lasers that each emit laser light, wherein the laser light is formed into a plurality of respective parallel collimated laser beams, wherein each laser beam includes at least one excitation wavelength that is blue in color, and wherein the wavelength-converted light is yellow in color.

13. The laser-excited-phosphor light source of claim 8, wherein a majority of the wavelength-converted light is in portions of the collimated beam that bypass the wavelength-selective reflector.

14. The laser-excited-phosphor light source of claim 8, further comprising:
an imager configured to spatially modulate each one of the repeating sequence of different colors to form a spatially modulated beam; and
projection optics operably coupled to receive light of the spatially modulated beam and to focus that light into a projected moving image.

15. A method comprising:
providing a color wheel that includes a plurality of wavelength-selective-filter areas each of which passes a different sub-range of visible-light colors;
rotating the color wheel around a rotational axis;
generating laser light having at least one excitation wavelength;
providing a phosphor plate mounted on a reflective second heatsink, wherein the phosphor plate, when illuminated by laser light, emits wavelength-converted light that includes a range of wavelengths longer than the laser light, wherein the emitted wavelength-converted light has a Lambertian spatial distribution, and wherein the phosphor plate scatters at least some of the laser light;
collimating light from the phosphor plate into a collimated beam having an optical axis;
reflecting the laser light using a wavelength-selective reflector oriented at an acute angle relative to the optical axis but positioned offset to a side of the optical axis, wherein the wavelength-selective reflector is configured to reflect wavelengths of the laser light toward the phosphor plate as reflected laser light;
focusing the reflected laser light onto the phosphor plate, wherein the wavelength-selective reflector is configured to transmit the range of wavelengths of the wavelength-converted light from the phosphor plate that are in a portion of the collimated beam that impinges on the wavelength-selective reflector;
focusing the collimated beam through the rotating color wheel and filtering the focused collimated beam through successive ones of the plurality of wavelength-selective-filter areas to form a beam having a repeating sequence of different colors; and
homogenizing the beam having the repeating sequence of different colors to form a homogenized beam having the repeating sequence of different colors.

16. The method of claim 15, wherein the wavelength-selective reflector is deposited only onto a selected area on a glass plate, wherein the selected area is offset from where the optical axis intersects the glass plate, and wherein the glass plate is oriented at a 45-degree angle to the optical axis.

17. The method of claim 15, wherein the focusing of the reflected laser light onto the phosphor plate is done from a first location that is offset to a first side of the optical axis, and wherein the phosphor plate also reflects at least some of the laser light from the laser array toward a direction to an opposite side of the optical axis relative to the first location such that the collimated beam includes the reflected light in a portion of collimated beam offset on an opposite side of the optical axis relative to the wavelength-selective reflector, and wherein a majority of the wavelength-converted light is in portions of the collimated beam that bypass the wavelength-selective reflector.

18. The method of claim 15, wherein the generating of the laser light includes forming a plurality of parallel collimated laser beams, wherein each laser beam includes at least one excitation wavelength that is blue in color, and wherein the wavelength-converted light is yellow in color.

19. The method of claim 15, wherein a majority of the wavelength-converted light is in one or more portions of the collimated beam that bypass the wavelength-selective reflector.

20. The method of claim 15, further comprising:
spatially modulating each one of the repeating sequence of different colors to form a spatially modulated beam; and
projecting light of the spatially modulated beam into a projected moving image.
